(19) United States
(12) Patent Application Publication
(10) Pub. No.: US 2026/0186315 A1
(43) Pub. Date: Jul. 2, 2026

(54) ANTI-SHAKE DRIVING DEVICE AND LENS MODULE

(71) Applicant: AAC Microtech (Changzhou) Co., Ltd., Changzhou City (CN)

(72) Inventors: Tong Zhang, Changzhou (CN); Wei Song, Changzhou (CN); Zhang Ren, Changzhou (CN)

(21) Appl. No.: 19/325,480

(22) Filed: Sep. 10, 2025

Related U.S. Application Data
(63) Continuation of application No. PCT/CN2024/144150, filed on Dec. 31, 2024.

(51) Int. Cl. G02B 27/64; G03B 5/04

(52) U.S. Cl. CPC G02B 27/646; G03B 5/04; G03B 2205/0015

(57) ABSTRACT

The embodiments of the present invention provide an anti-shake driving device and lens module, the anti-shake driving device include a housing having an accommodation space, an anti-shake movable portion received within the accommodation space, an optical element having an optical axis and fixed to the anti-shake movable portion, an elastic support assembly movably suspending the anti-shake movable portion within the accommodation space, a driving assembly configured to drive the anti-shake movable portion to move relative to the housing in a plane perpendicular to the optical axis and an anti-collision assembly disposed between the anti-shake movable portion and the housing. The configured damping gel package effectively prevents the damping gel from deforming or rupturing when subjected to external impact, thereby ensuring stable performance.

### CROSS-REFERENCE TO RELATED APPLICATIONS

This application is a continuation of International Application No. PCT/CN2024/144150, filed on December 31, 2024, the entire content of which is incorporated herein by reference.

### TECHNICAL FIELD

The present invention relates to the technical field of anti-shake driving, in particular to an anti-shake driving device and a lens module.

### BACKGROUND

In the camera motor, the damping gel is configured to dampen vibrations during the motor's operation, improving the stability and precision of the motor's movement, thereby enhancing the camera's focusing and anti-shake performance.

In current market products, the technical solution generally involves directly injecting damping gel into a receiving groove, with portions of the damping gel exposed. However, the damping gel exhibits low structural strength and is prone to deformation or splattering under external impact. Consequently, during assembly or operation of the motor module, external forces may cause the damping gel to deform, rupture, or even generate contaminating particles, thereby degrading its damping performance and affecting the camera's imaging quality.

### SUMMARY

The present invention aim to address at least one of the technical problems in the prior art by providing an anti-shake driving device and a lens module.

In one aspect, the embodiments of the present invention provide an anti-shake driving device, including a housing having an accommodation space; an anti-shake movable portion received within the accommodation space; an optical element having an optical axis and fixed to the anti-shake movable portion; an elastic support assembly movably suspending the anti-shake movable portion within the accommodation space; a driving assembly configured to drive the anti-shake movable portion to move relative to the housing in a plane perpendicular to the optical axis; and an anti-collision assembly disposed between the anti-shake movable portion and the housing; and the anti-collision assembly includes: an anti-collision member disposed on the anti-shake movable portion; and a damping gel package disposed on a side of the anti-collision member facing the housing and connected to the housing; and the damping gel package includes: a flexible outer shell; and damping gel encapsulated within the flexible outer shell.

Optionally, the anti-collision member is located between the housing and the anti-shake movable portion, the flexible outer shell is a polymer film outer shell.

Optionally, a side of the anti-collision member facing the housing is provided with a receiving groove, and the damping gel package is disposed within the receiving groove.

Optionally, the receiving groove is disposed in a central region of the side of the anti-collision member facing the housing, and the damping gel package protrudes from a surface of the side of the anti-collision member facing the housing.

Optionally, the anti-shake movable portion comprises a base and an anti-shake bracket both fixed to the elastic support assembly; the optical element comprises an image sensor fixed to the base; the anti-shake bracket surrounds the image sensor; and the anti-collision member is connected to the anti-shake bracket.

Optionally, the elastic support assembly includes a first support spring sheet fixed to the base; a second support spring sheet surrounding and spaced apart from the first support spring sheet; and a connecting portion connecting the first support spring sheet and the second support spring sheet; the second support spring sheet is fixed to the housing; the anti-collision member is disposed between the second support spring sheet and the anti-shake bracket, and a side of the anti-collision member facing away from the anti-shake bracket is connected to the second support spring sheet.

Optionally, the anti-shake driving device includes at least one pair of the anti-collision assemblies; each pair of the anti-collision assemblies is disposed on opposite sides of the anti-shake bracket respectively.

Optionally, the second support spring sheet includes a body portion disposed around the first support spring sheet; and an extension portion bent and extending from the body portion; the extension portion and the anti-collision member are disposed on different sides of the anti-shake bracket, and the elastic support assembly is fixed to the housing via the extension portion.

Optionally, the driving assembly includes a coil fixed to one of the anti-shake bracket and the housing; and a magnetic steel fixed to the other of the anti-shake bracket and the housing; the magnetic steel is disposed opposite to the coil.

In another aspect, the embodiments of the present invention provide a lens module, including: a lens; the anti-shake driving device as the previously recorded, the housing is provided with a through-hole, and light sequentially passes through the lens and the through-hole to reach the optical element.

In the anti-shake driving device and lens module of the present invention, the configured damping gel package effectively prevents the damping gel from deforming or rupturing when subjected to external impact, thereby ensuring stable performance and eliminating the risk of gel particle contamination in the lens module.

### BRIEF DESCRIPTION OF THE DRAWINGS

In order to explain the technical solutions of the embodiments of the present invention more clearly, the following will briefly introduce the accompanying drawings used in the embodiments. Apparently, the drawings in the following description are only some embodiments of the present invention. Those of ordinary skill in the art can obtain other drawings based on these drawings without creative work.

FIG. 1 is a perspective view of an anti-shake driving device according to an embodiment of the present invention;

FIG. 2 is a cross-sectional view taken along line A-A in FIG. 1;

FIG. 3 is an exploded perspective view of FIG. 1; and

FIG. 4 is a schematic view of FIG. 1 with a top cover plate removed.

### DETAILED DESCRIPTION OF THE EMBODIMENTS

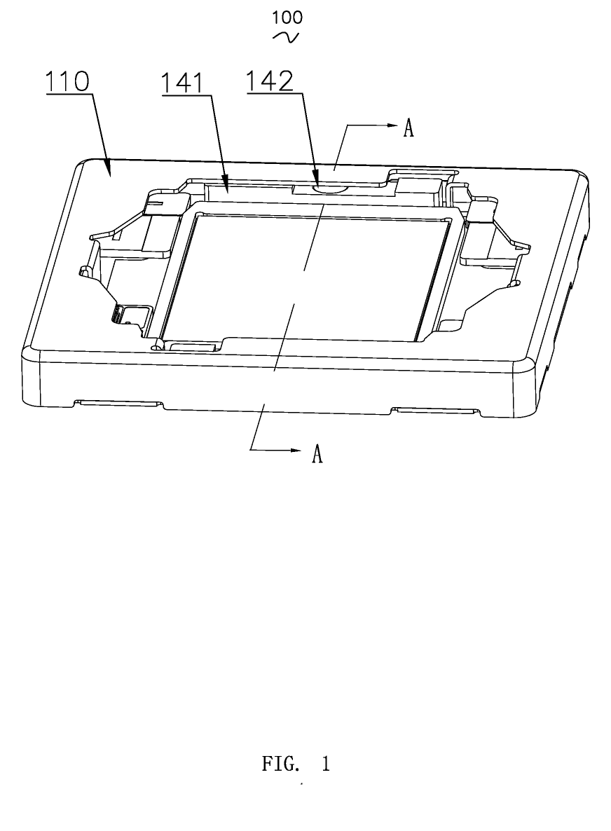

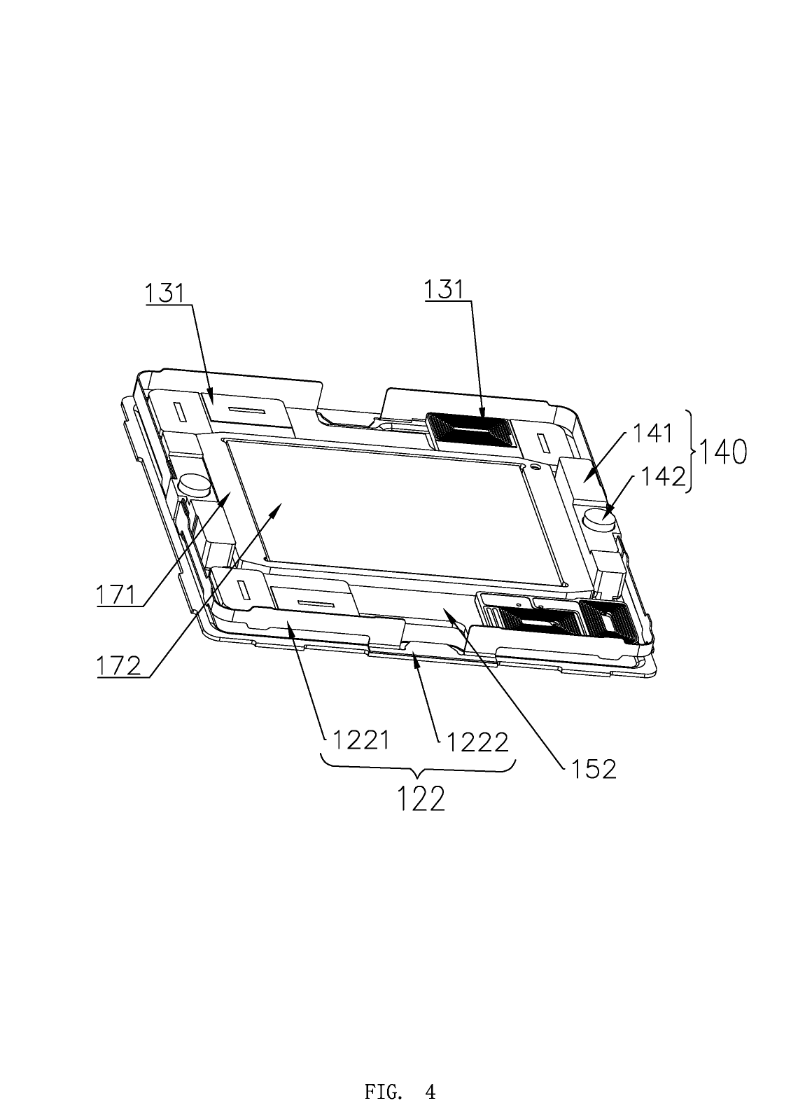

To enable those skilled in the art to better understand the technical solutions of the present invention, the present invention will be described in further detail below with reference to the accompanying drawings and specific embodiments. As shown in FIGS. 1 to 4, an anti-shake driving device 100 includes: a housing 110 having an accommodation space 101; an anti-shake movable portion 150 received within the accommodation space 101; an optical element 160 having an optical axis 200 and fixed to the anti-shake movable portion 150; an elastic support assembly 120 movably suspending the anti-shake movable portion 150 within the accommodation space 101; a driving assembly 130 configured to drive the anti-shake movable portion 150 to move relative to the housing 110 in a plane perpendicular to the optical axis 200; and an anti-collision assembly 140 disposed between the anti-shake movable portion 150 and the housing 110.

The anti-collision assembly 140 includes an anti-collision member 141 disposed on the anti-shake movable portion 150, and a damping gel package 142 disposed on a side of the anti-collision member 141 facing the housing 110 and connected to the housing 110. The damping gel package 142 includes a flexible outer shell 1421 and damping gel 1422 encapsulated within the flexible outer shell 1421.

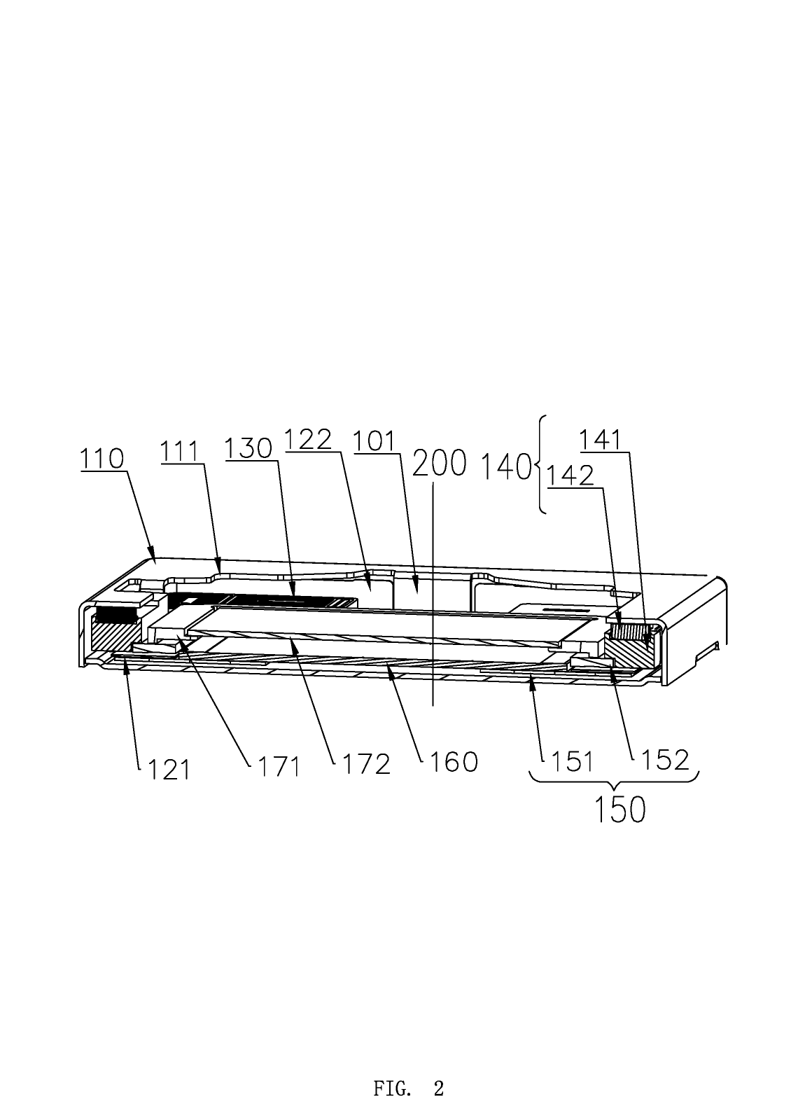

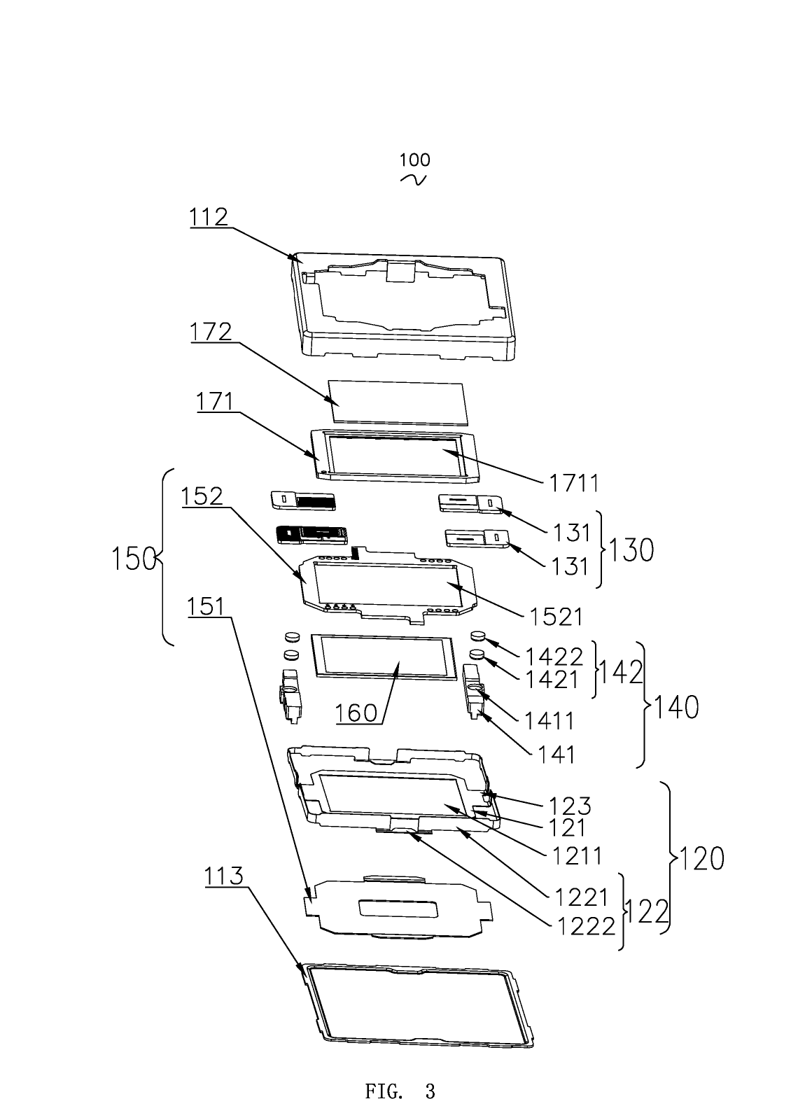

Specifically, as shown in FIGS. 1 to 4, the anti-shake movable portion 150 is movably suspended within the accommodation space 101 of the housing 110 by the elastic support assembly 120. The anti-shake movable portion 150 is further provided with an optical element 160 having an optical axis 200, and the optical element 160 is fixedly connected to the anti-shake movable portion 150. By way of example, as shown in FIGS. 2 and 3, the anti-shake driving device 100 further includes a filter bracket 171 and a filter 172. The filter bracket 171 is disposed on the anti-shake movable portion 150, and a central region of the filter bracket 171 has a placement through-slot 1711 configured to receive the filter 172.

Under the driving action of the driving assembly 130, the anti-shake movable portion 150 is capable of moving relative to the housing 110 in a plane perpendicular to the optical axis 200. The optical element 160 moves together with the anti-shake movable portion 150 relative to the housing 110 in the plane perpendicular to the optical axis 200. During the movement, the damping gel package 142 disposed on the anti-collision member 141 can effectively resist external impacts. The damping gel package 142 is fabricated by encapsulating the damping gel 1422 within the flexible outer shell 1421. It should be noted that the movement of the anti-shake movable portion in the plane perpendicular to the optical axis includes its ability to translate and rotate within this plane.

Further, the flexible outer shell 1421 is a polymer film outer shell. Specifically, the damping gel package 142 is formed by encapsulating the damping gel 1422 within the polymer film outer shell, creating an encapsulated structure. Compared with the damping gel itself, the polymer film outer shell has significantly improved strength and resistance to external impact. During subsequent assembly and operation of the lens module (e.g., motor module), it will not deform or rupture due to external impact, exhibiting more stable performance and avoiding gel particle contamination of the lens module.

Exemplarily, as shown in FIGS. 1 to 4, the anti-collision member 141 is provided with a receiving groove 1411 on a side facing the housing 110, and the damping gel package 142 is disposed within the receiving groove 1411.

Specifically, as shown in FIGS. 1 to 4, the anti-collision member 141 is provided with a receiving groove 1411 at its top portion. The receiving groove 1411 is configured to accommodate and fixedly secure the damping gel package 142 therein, such as by means of adhesive bonding or snap-fit engagement. The arrangement of the receiving groove enables the damping gel package to be more securely attached to the anti-collision member, thereby not only enhancing impact protection but also optimizing spatial utilization.

Further, the receiving groove 1411 is disposed in a central region of the anti-collision member 141 on a side facing the housing 110.

Furthermore, the damping gel package 142 protrudes from the surface of the anti-collision member 141 facing the housing 110. One end of the damping gel package 142 is disposed within the receiving groove 1411, and the other end protrudes from the receiving groove 1411 and beyond the surface of the anti-collision member 141 facing the housing 110. Additionally, the damping gel package 142 may be configured in a columnar structure. Alternatively, the damping gel package 142 may also be designed in other shapes, provided that it is configured to match the receiving groove 1411 and can protrude from the surface of the anti-collision member 141 facing the housing 110.

Exemplarily, as shown in FIGS. 1 to 4, the anti-shake movable portion 150 includes a base 151 fixed to the elastic support assembly 120 and an anti-shake bracket 152 also fixed to the elastic support assembly 120. The optical element 160 includes an image sensor fixed to the base 151. The anti-shake bracket 152 surrounds the image sensor, and the anti-collision member 141 is connected to the anti-shake bracket 152.

Further, the elastic support assembly 120 includes a first support spring sheet 121 fixed to the base 151, a second support spring sheet 122 surrounding the first support spring sheet 121 and spaced apart therefrom, and a connecting portion 123 connecting the first support spring sheet 121 and the second support spring sheet 122. The second support spring sheet 122 is fixed to the housing 110. The anti-collision member 141 is disposed between the second support spring sheet 122 and the anti-shake bracket 152, and a side of the anti-collision member 141 facing away from the anti-shake bracket 152 is connected to the second support spring sheet 122.

Specifically, as shown in FIGS. 1 to 4, a first through-hole 1211 is defined in a central region of the first support spring sheet 121. The base 151 is disposed on a lower side of the first support spring sheet 121, and the anti-shake bracket 152 surrounds an upper side of the first support spring sheet 121. A second through-hole 1521 is defined in a central region of the anti-shake bracket 152. The image sensor is fixed on the base 151 and corresponds to the second through-hole 1521. The filter bracket 171 is disposed on a side of the anti-shake bracket 152 facing away from the first support spring sheet 121.

The second support spring sheet 122 includes a body portion 1221 disposed around the first support spring sheet 121, and an extension portion 1222 bent and extending from the body portion 1221. The extension portion 1222 and the anti-collision member 141 are disposed on different sides of the anti-shake bracket 152, and the elastic support assembly 120 is fixed to the housing 110 via the extension portion 1222. Optionally, the elastic support assembly 120 is fixed to the housing 110 only via the extension portion 1222.

As shown in FIGS. 1 to 4, the housing 110 includes an upper cover plate 112 and a lower base plate 113. A through-hole 111 is defined at a top portion of the upper cover plate 112 for light to enter. The extension portion 1222 is fixed to the lower base plate 113, thereby suspending the body portion 1221 within the accommodation space 101 and further suspending the first support spring sheet 121 within the accommodation space 101. Left and right sides of the anti-collision member 141 are connected to the anti-shake bracket 152 and the body portion 1221, respectively. The anti-shake movable portion 150 is disposed on the first support spring sheet 121.

The driving assembly 130 includes a coil 131 fixed to one of the anti-shake bracket 152 and the housing 110, and a magnetic steel (not shown in the figures) fixed to the other of the anti-shake bracket 152 and the housing 110 and disposed opposite to the coil 131. As a specific example, as shown in FIGS. 2 to 4, the coil 131 is disposed in an edge region of a side of the anti-shake bracket 152 facing away from the base 151. For example, one coil 131 is respectively arranged at each of the four corners of the side of the anti-shake bracket 152 facing away from the base 151. Additionally, magnetic steels are respectively disposed at positions corresponding to the four coils 131 on the top inner wall of the upper cover plate 112, which are configured to drive the image sensor to actuate and drive the elastic support assembly 120 to actuate, and both the image sensor and the elastic support assembly are movable in a plane perpendicular to the optical axis.

It should be noted that the embodiments of the present invention are applicable not only to technical solutions such as sensor shift and Voice Coil Motor (VCM) but also to other camera motors, and the present invention is not limited in terms of specific implementations.

As another specific example, the anti-shake movable portion 150 includes a lens assembly. One end of the lens assembly is supported by the elastic support assembly 120, and the other end of the lens assembly is mounted in the through-hole 111 of the housing 110. The lens assembly, under the driving action of the driving assembly 130, is movable in a plane perpendicular to the optical axis 200.

Exemplarily, as shown in FIGS. 1 to 4, the anti-shake driving device 100 includes at least one pair of the anti-collision assemblies 140. Each pair of the anti-collision assemblies 140 is disposed on opposite sides of the anti-shake bracket 152, respectively.

Specifically, as shown in FIGS. 1 to 4, a pair of anti-collision assemblies 140 are symmetrically disposed at left and right side positions of the anti-shake bracket 152. Alternatively, the anti-collision assemblies 140 may be provided in different quantities such as one pair, two pairs, or three pairs according to actual application requirements.

The anti-shake driving device according to this embodiment of the present invention utilizes the provided damping gel package to prevent deformation and rupture of the damping gel under external impact, thereby ensuring more stable performance and avoiding contamination of the lens module by gel particles, which further improves imaging quality. Additionally, it enhances the stability and precision of motor movement, thereby providing superior autofocus and anti-shake performance for the camera.

In another aspect, the present invention further provides a lens module including: a lens; and the anti-shake driving device as described in the foregoing embodiments, wherein the specific structure of the anti-shake driving device may refer to the related descriptions above and will not be reiterated herein. The housing is provided with a through-hole, wherein light sequentially passes through the lens and the through-hole to reach the optical element.

What is claimed is:

1. An anti-shake driving device, comprising:
a housing having an accommodation space;
an anti-shake movable portion received within the accommodation space;
an optical element having an optical axis and fixed to the anti-shake movable portion;
an elastic support assembly movably suspending the anti-shake movable portion within the accommodation space;
a driving assembly configured to drive the anti-shake movable portion to move relative to the housing in a plane perpendicular to the optical axis; and
an anti-collision assembly disposed between the anti-shake movable portion and the housing;
wherein the anti-collision assembly comprises:
an anti-collision member disposed on the anti-shake movable portion; and
a damping gel package disposed on a side of the anti-collision member facing the housing and connected to the housing;
wherein the damping gel package comprises:
a flexible outer shell; and
damping gel encapsulated within the flexible outer shell.

2. The anti-shake driving device of claim 1, wherein the flexible outer shell is a polymer
film outer shell.

3. The anti-shake driving device of claim 1, wherein a side of the anti-collision member facing the housing is provided with a receiving groove, and the damping gel package is disposed within the receiving groove.

4. The anti-shake driving device of claim 3, wherein the receiving groove is disposed in a central region of the side of the anti-collision member facing the housing, and the damping gel package protrudes from a surface of the side of the anti-collision member facing the housing.

5. The anti-shake driving device of claim 1, wherein the anti-shake movable portion comprises a base and an anti-shake bracket both fixed to the elastic support assembly; the optical element comprises an image sensor fixed to the base; the anti-shake bracket surrounds the image sensor; and the anti-collision member is connected to the anti-shake bracket.

6. The anti-shake driving device of claim 5, wherein the elastic support assembly comprises:
a first support spring sheet fixed to the base;
a second support spring sheet surrounding and spaced apart from the first support
spring sheet; and
a connecting portion connecting the first support spring sheet and the second support spring sheet;
the second support spring sheet is fixed to the housing; the anti-collision member is disposed between the second support spring sheet and the anti-shake bracket, and a side of the anti-collision member facing away from the anti-shake bracket is connected to the second support spring sheet.

7. The anti-shake driving device of claim 5, wherein the anti-shake driving device comprises at least one pair of the anti-collision assemblies; each pair of the anti-collision assemblies is disposed on opposite sides of the anti-shake bracket respectively.

8. The anti-shake driving device of claim 6, wherein the second support spring sheet comprises:
a body portion disposed around the first support spring sheet; and
an extension portion bent and extending from the body portion;
the extension portion and the anti-collision member are disposed on different sides of the anti-shake bracket, and the elastic support assembly is fixed to the housing via the extension portion.

9. The anti-shake driving device of claim 5, wherein the driving assembly comprises:
a coil fixed to one of the anti-shake bracket and the housing; and
a magnetic steel fixed to the other of the anti-shake bracket and the housing;
the magnetic steel is disposed opposite to the coil.

10. A lens module, comprising:
a lens; and
the anti-shake driving device according to claim 1,
wherein the housing is provided with a through-hole, and light sequentially passes through the lens and the through-hole to reach the optical element.
